(19) United States
(12) Patent Application Publication
(10) Pub. No.: US 2005/0220273 A1
(43) Pub. Date: Oct. 6, 2005

(54) Digital radiography system

(76) Inventor: Friedrich Ueffinger, Rochester, NY (US)

Correspondence Address: Pamela R. Crocker;Patent Legal Staff, Eastman Kodak Company, 343 State Street, Rochester, NY, 14650-2201, US

(21) Appl. No.: 11/096,849

(22) Filed: Apr. 1, 2005

Related U.S. Application Data
(60) Provisional application No. 60/558,815, filed on Apr. 2, 2004.

(51) Int. Cl. H05G 1/02

(52) U.S. Cl. 378/197

(57) ABSTRACT

A digital radiography apparatus. The digital radiography apparatus comprises an x-ray source, a detecting member, a mounting member, and a telescoping member. The telescoping member is mounted to an overhead member. One end of the telescoping member is adapted for discrete translational movement along a z-axis such that the one end moves between a first position and a second position extending away from the overhead member. The mounting member is mounted to the one end of the telescoping member and is rotatable about an x-axis and y-axis. The x-ray source and detecting member are mounted to the mounting member in an aligned relationship and are movable in translation relative to each other.

### CROSS REFERENCE TO RELATED APPLICATION

Reference is made to, and priority is claimed from, provisional patent application U.S. Ser. No. 60/558,815 entitled “DIGITAL RADIOGRAPHY SYSTEM” , filed on Apr. 2, 2004 in the name of Ueffinger, which is assigned to the assignee of this application, and incorporated herein by reference.

### FIELD OF THE INVENTION

The invention relates to digital radiography, and in particular to a digital radiography system.

### BACKGROUND OF THE INVENTION

Digital radiography systems are well known. In such digital radiography system, an x-ray source projects an x-ray beam through an object (such as a body part of an individual) to produce an x-ray image captured by a detecting member. The detector member can rely on direct conversion of x-rays to charge carriers or alternatively indirect conversion in which x-rays are converted to light which is then converted to charge carriers and charge readout.

The detector is typically mounted in a structure/member known as a bucky. The bucky can also house other elements, for example, but not limited to, an anti-scatter grid which is commonly used to prevent scattered radiation from affecting the final x-ray image. Such anti-scatter grids are typically employed when the object to be imaged is relatively thick (for example, a human chest).

The x-ray source and/or detector/bucky can be mounted in various configurations. For example, the detector/bucky can be mounted on an x-ray table or on a radiographic stand, as shown in FIGS. 1A and 1B, respectively, wherein the detector/bucky is element 10. As shown in FIGS. 1A and 1B, the x-ray source (element 15) is mounted on a support structure.

However, such configurations shown in FIGS. 1A and 1B require access to the floor. That is, the support structure(s) for the x-ray source and/or detector/bucky requires access to the floor. In some situations, such floor access may not be possible, for example, if there is limited space. In other situations, such a floor-based support structure may not be desired, for example, in an emergency room wherein equipment may need to be moved quickly.

As such, there exists a need for a digital radiography system which is not supported by a floor-based support structure.

### SUMMARY OF THE INVENTION

An object of the present invention is to provide an digital radiography system for mounting an x-ray source and detector member in a plurality of mounting configurations.

Another object of the present invention is to provide such an system which is not supported by a floor-based support structure.

This object is given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a digital radiography apparatus. The digital radiography apparatus comprises an x-ray source, a detecting member, a mounting member, and a telescoping member. The telescoping member is mounted to an overhead member. One end of the telescoping member is adapted for discrete translational movement along a z-axis such that the one end moves between a first position and a second position extending away from the overhead member. The mounting member is mounted to the one end of the telescoping member and is rotatable about an x-axis and y-axis. The x-ray source and detecting member are mounted to the mounting member in an aligned relationship and are movable in translation relative to each other.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIGS. 1A and 1B show prior art mounting configurations for a digital radiography system.

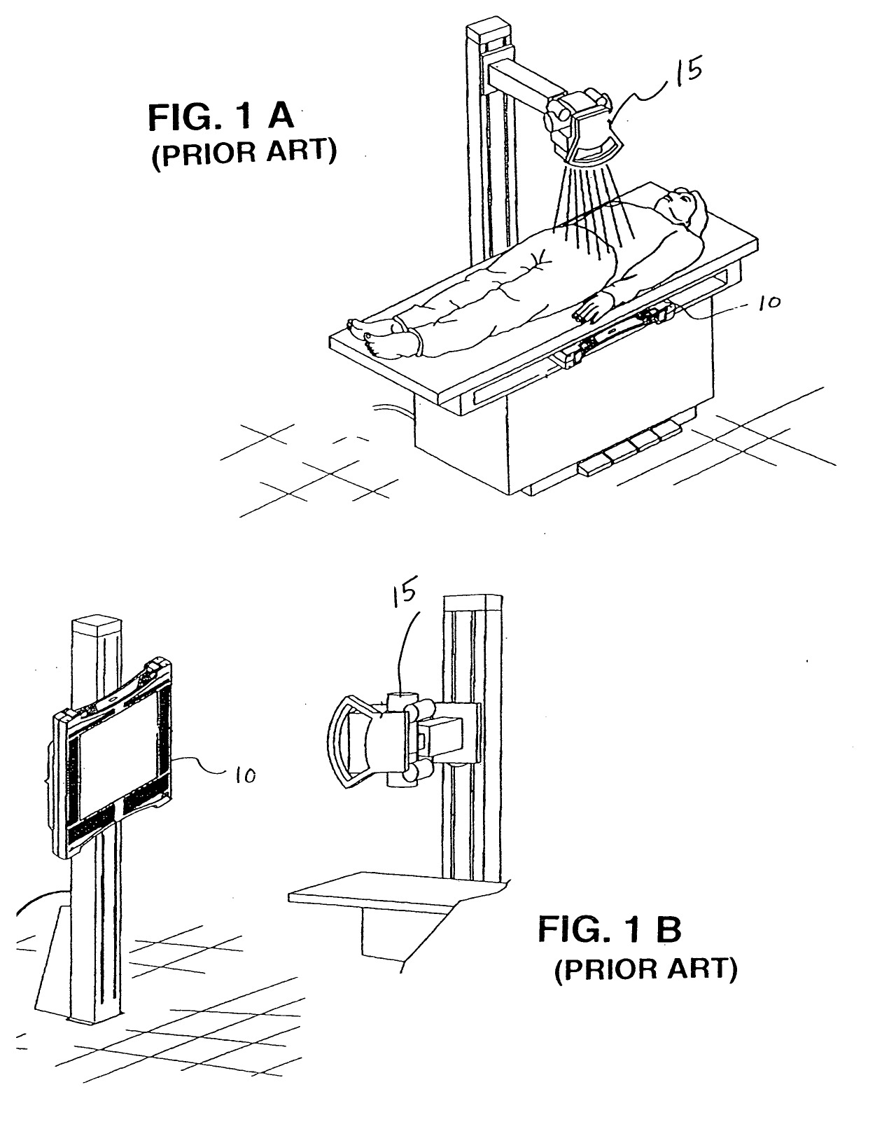

FIG. 2 shows a diagrammatic perspective view of a digital radiography system in accordance with the present invention.

FIG. 3 shows a diagrammatic perspective view of a digital radiography system in accordance with the present invention.

FIG. 4 shows a diagrammatic perspective view of a digital radiography system in accordance with the present invention.

FIG. 5 shows a diagrammatic perspective view of a digital radiography system in accordance with the present invention.

FIG. 6 shows a diagrammatic perspective view of a digital radiography system in accordance with the present invention.

FIG. 7 shows a diagrammatic perspective view of a digital radiography system in accordance with the present invention.

FIG. 8 shows a diagrammatic perspective view of a digital radiography system in accordance with the present invention.

FIG. 9 shows a diagrammatic perspective view of a digital radiography system in accordance with the present invention.

FIG. 10 shows a diagrammatic perspective view of a digital radiography system in accordance with the present invention.

FIG. 11 shows a diagrammatic perspective view of a digital radiography system in accordance with the present invention.

FIG. 12 shows a diagrammatic perspective view of a digital radiography system in accordance with the present invention.

FIG. 13 shows a diagrammatic perspective view of a digital radiography system in accordance with the present invention.

FIG. 14 shows a diagrammatic perspective view of a digital radiography system in accordance with the present invention.

FIG. 15 shows a diagrammatic perspective view of a digital radiography system in accordance with the present invention.

FIG. 16 shows a diagrammatic perspective view of a digital radiography system in accordance with the present invention.

FIG. 17 shows a diagrammatic perspective view of a digital radiography system in accordance with the present invention.

FIG. 18 shows a diagrammatic perspective view of a digital radiography system in accordance with the present invention.

FIG. 19 shows a diagrammatic perspective view of a digital radiography system in accordance with the present invention.

FIG. 20 shows a diagrammatic perspective view of a digital radiography system in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The present invention is directed to a digital radiography (DR) system wherein an x-ray source projects an x-ray beam through a body part of an individual (or an object) to product an x-ray image captured by a detecting member.

The present invention provides a source and detecting member which can be moved/positioned in various orientations so that various body parts can be imaged.

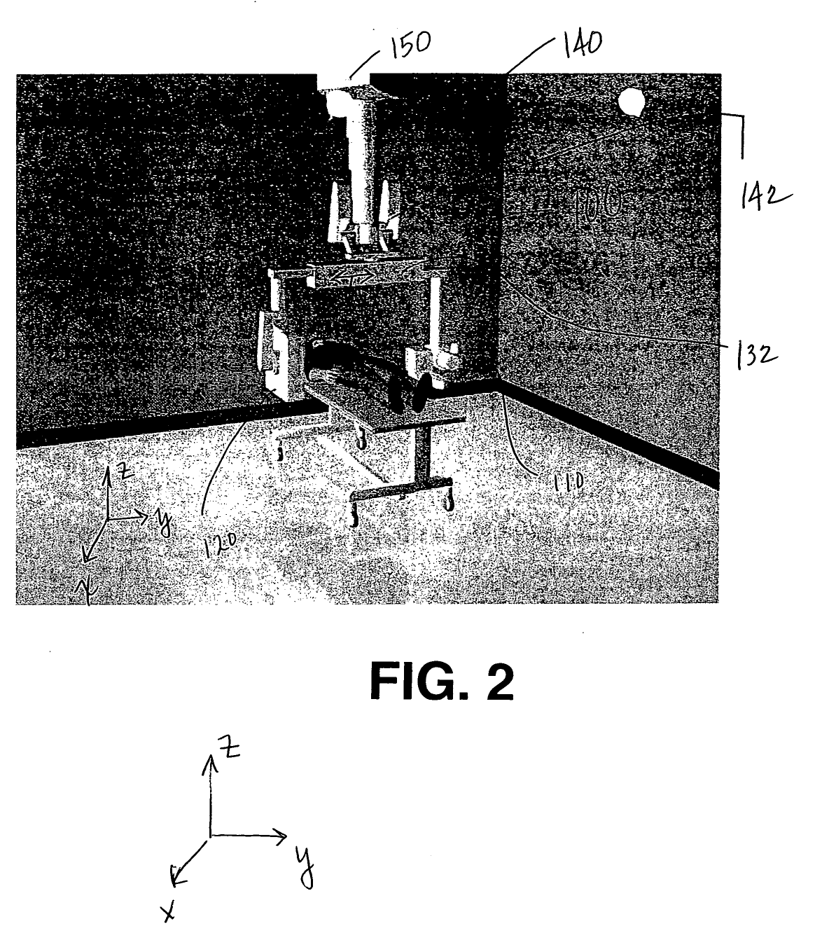

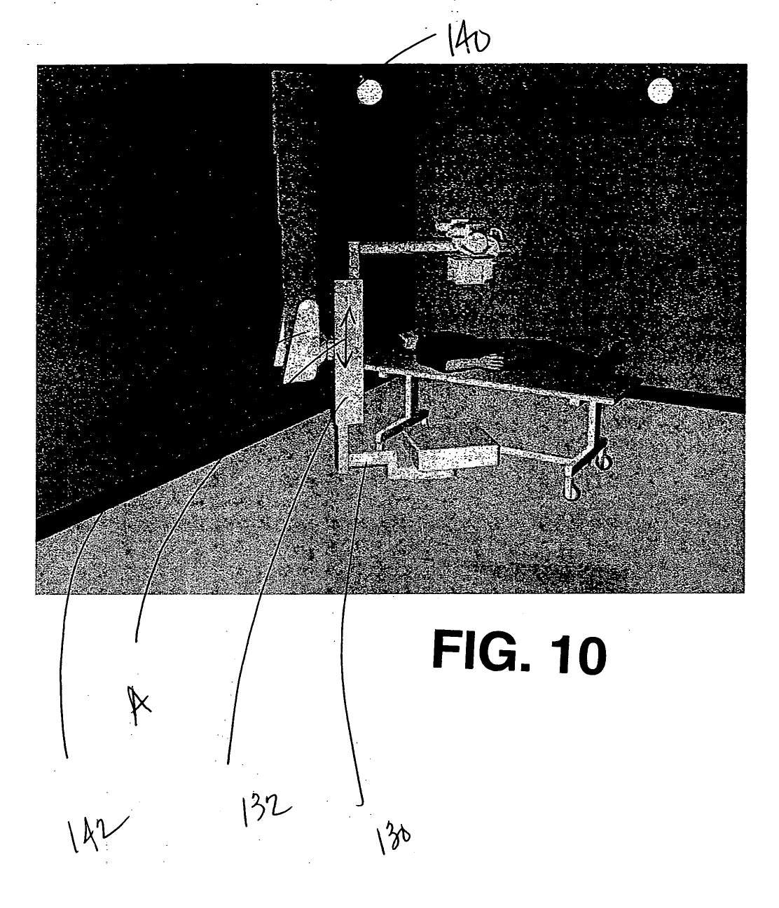

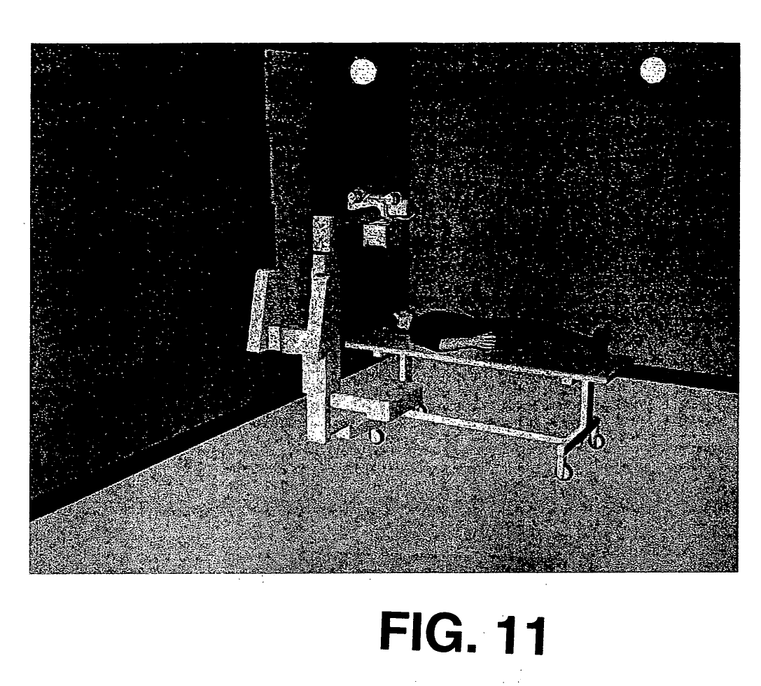

FIGS. 2-20 show diagrammatic perspective views of a digital radiography (DR) system 100 in accordance with the present invention.

DR system 100 includes an x-ray source 110, a detecting member 120, a mounting member 130, a translation assembly 132, a telescoping member 140, and a mounting assembly 142.

X-ray source 110 and detecting member 120 are mounted on mounting member 130.

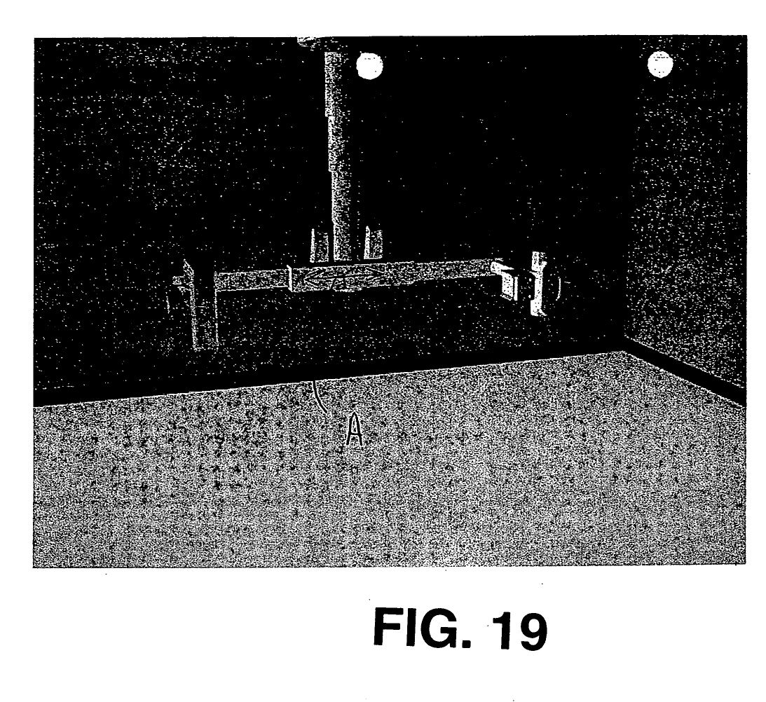

Mounting member 130 includes translation assembly 132 (known to those skilled in the art) to provide translational movement (shown by arrow A in FIGS. 2 and 19) between x-ray source 110 and detecting member 120.

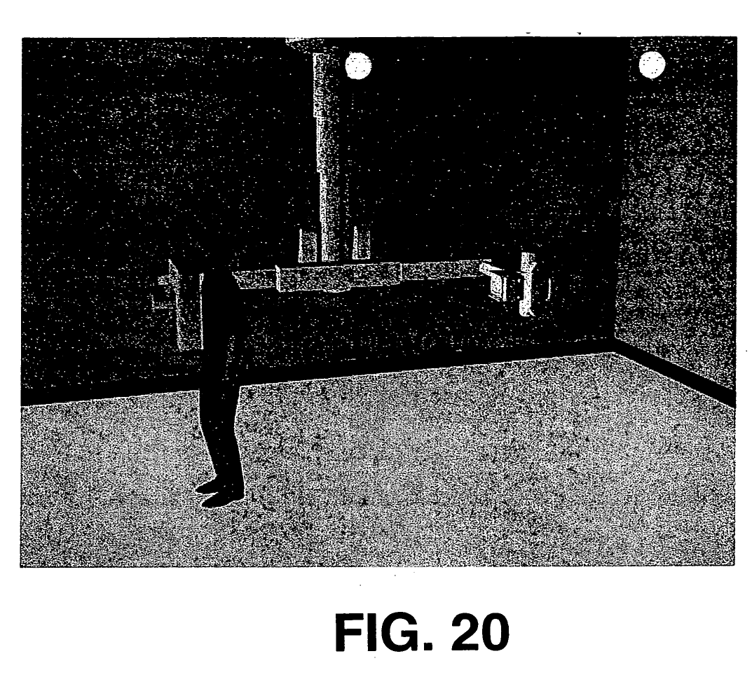

As shown in the figures, this translational movement allows x-ray source 110 and detecting member 120 to remain in an opposed aligned relationship so that a digital image can be captured. Yet, this translational movement allows for the various placement/positioning of the individual, for example, in a standing, sitting, or reclining position. As shown in FIG. 2, a table can be placed between the x-ray source and detecting member. FIGS. 19 and 20 shown how the distance between the two elements can be extended (in the direction of arrow A) to allow for another type of image to be captured.

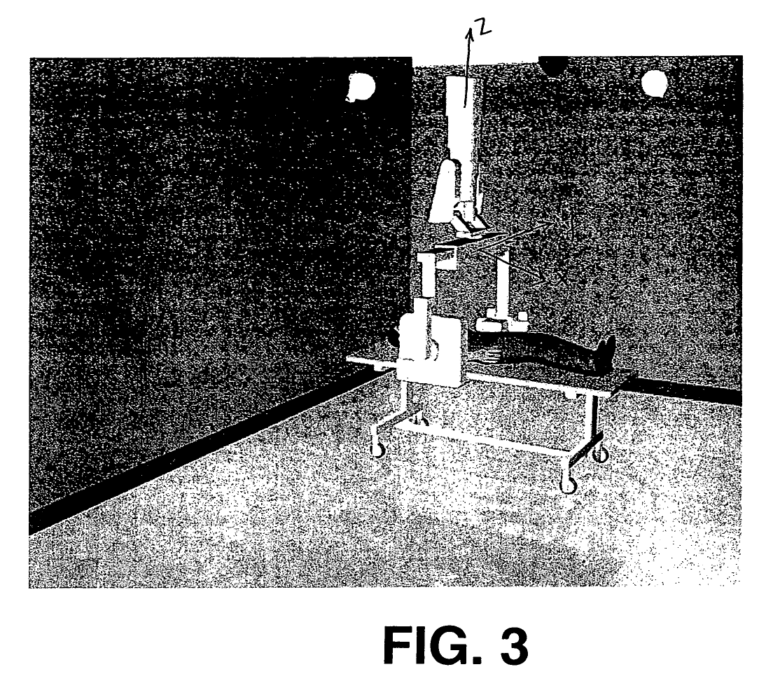

Mounting member 130 is mounted to telescoping member 140 by mounting assembly 142 (known to those skilled in the art). As shown in FIGS. 3 through 5, assembly 142 allows mounting member 130 to pivotally move relative to telescoping member 140. FIGS. 3 through 5 show such pivoting motion over a 90 degree angle. By such motion, the translation motion (direction along arrow A) of the x-ray source and detecting member remains substantially perpendicular to telescoping member 140.

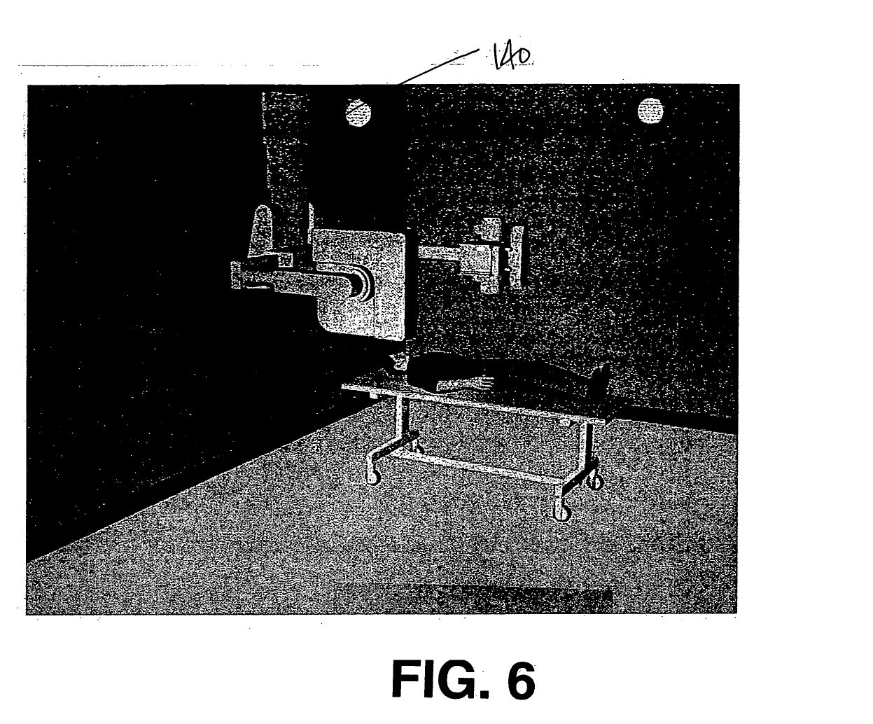

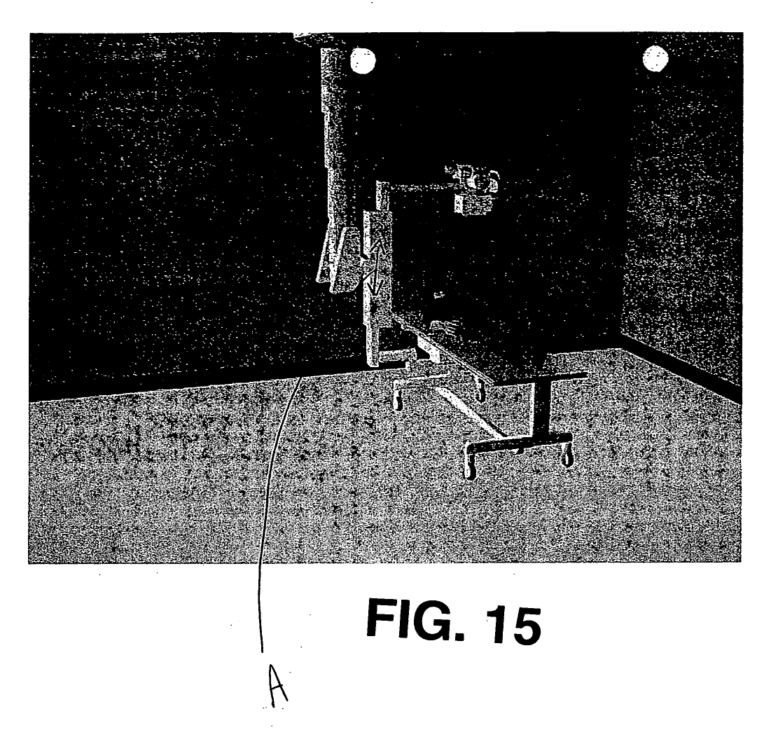

Mounting assembly 142 also allows mounting member 130 to rotatably move relative to telescoping member 140. FIGS. 6 through 8 show mounting member 130 rotating 90 degrees relative to telescoping member 140. This rotational movement allows the x-ray source and detecting member to image an individual disposed in a reclining position, such as shown in FIG. 15. By this motion, the translation motion (direction along arrow A) of the x-ray source and detecting member is now directly substantially parallel to telescoping member 140, as best shown in FIG. 15.

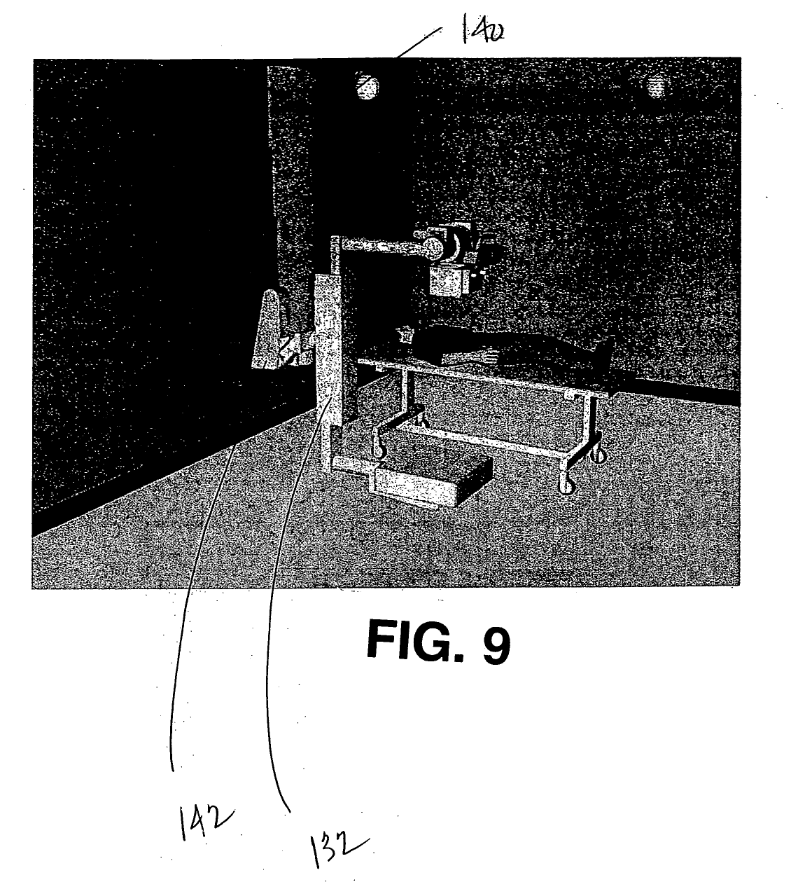

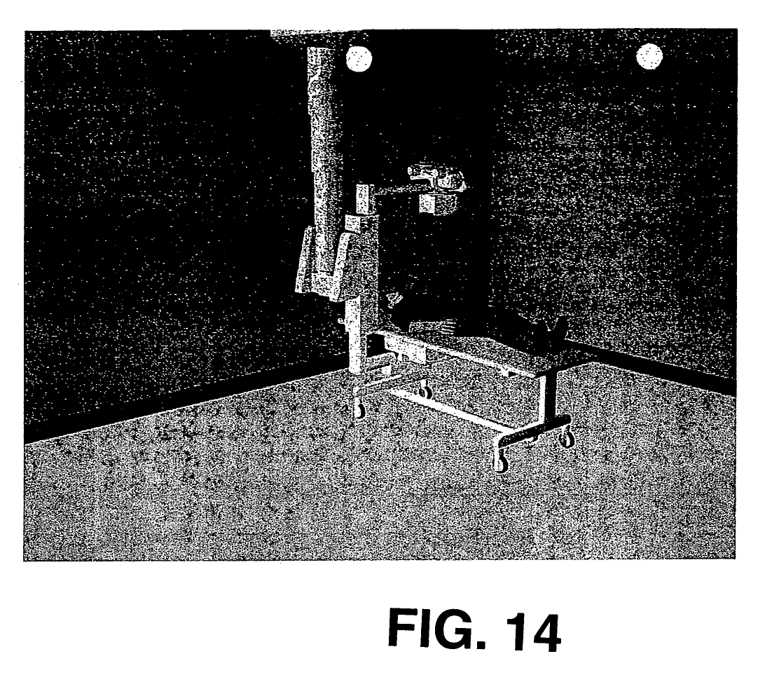

Mounting assembly 142 also allows mounting member 130 to rotate about telescoping member 140. If telescoping member 140 is disposed along the z-axis, then this rotation of mounting member is about the z-axis. This motion is best shown in FIGS. 9 through 11. As shown in these figures, the translation motion (direction along arrow A) is substantially parallel to telescoping member 140, and this relationship is maintained as mounting assembly 142 rotates mounting member 130 about telescoping member 140. By this motion, the x-ray source and detecting member can be positioned above/below a table to image a reclining individual, as best shown in FIGS. 14-15.

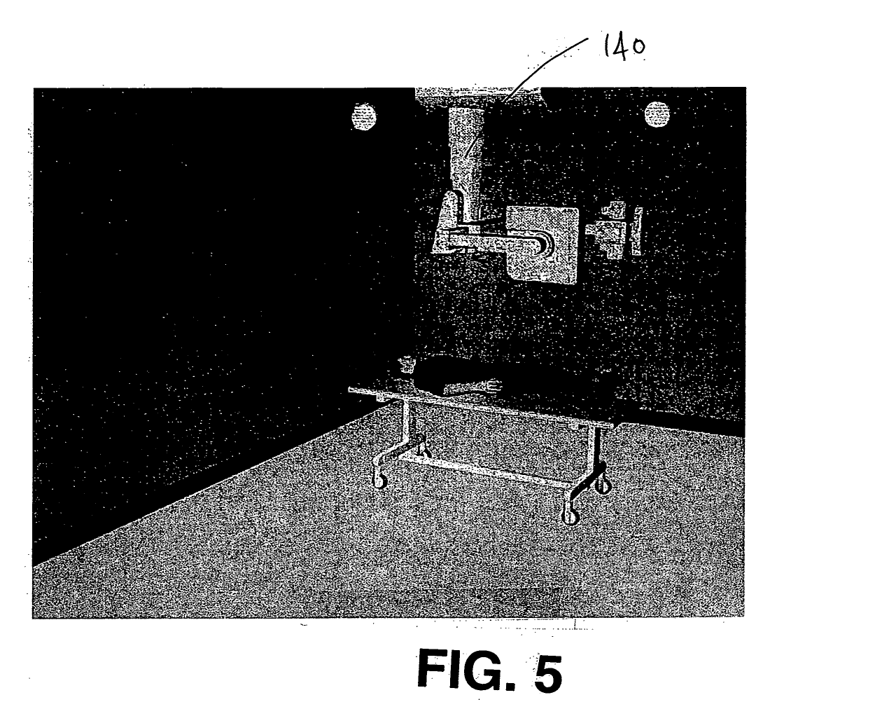

Telescoping member 140 is mounted to an overhead support 150 by a translation assembly so as to provide translational movement of telescoping member 140 relative to a ceiling or other overhead structure such as an overhead beam. By attaching DR system 100 to the ceiling/overhead, no floor space is required. This motion allows a user to move DR system 100 to various parts of the room. For example, when the system is not in use, it may be moved to a corner location. This movement of the DR system is illustrated in FIGS. 5 and 6 wherein DR system 100 is moved away from a table.

Telescoping member 140 is adapted to move translationally between a first and second position, which can be referred to as a collapsed position and an extended position. That is, telescoping member 140 is configured to slide inward and outward in overlapping sections, similar to the cylindrical sections of a small hand telescope. Telescoping motion is well known to those skilled in the art.

In its collapsed position, the telescoping member is disposed toward the ceiling. In its extended position, the telescoping member is directed away from the ceiling, extending outward toward the floor. Telescoping member 140 is configured to extended at discrete positions intermediate its collapsed and extended positions. This motion allows for the imaging of objects of various heights between the telescoping member's two extreme positions.

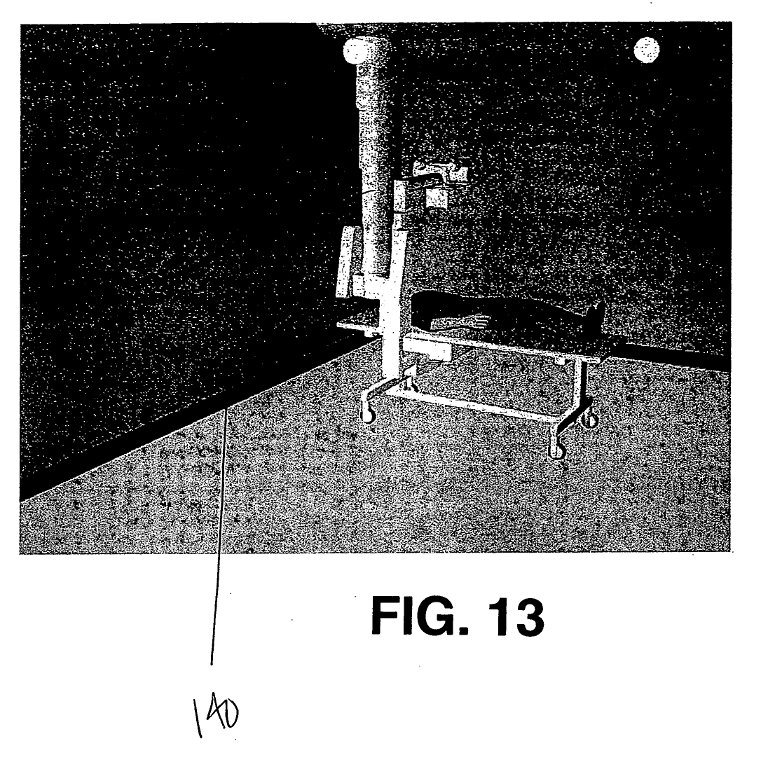

For example, FIG. 5 shows telescoping member 140 in an intermediate position between its collapsed and extended positions (i.e., partially collapsed; not collapsed or extended). FIG. 13 shows telescoping member 140 in another intermediate position wherein the member is extended further than the position shown in FIG. 5.

This telescoping feature of member 140 allows DR system 100 to reach various body parts of the individual being imaged—whether the individual is reclining on a table (such as shown in FIG. 2) or standing (such as shown in FIG. 2), or sitting.

FIGS. 2 through 20 show DR system 100 in various positions to more particularly illustrated the versatility of the present invention. As shown in FIG. 2, DR system 100 can image sides view of a reclining individual, wherein detecting member 120 is substantially perpendicular to telescoping member 140.

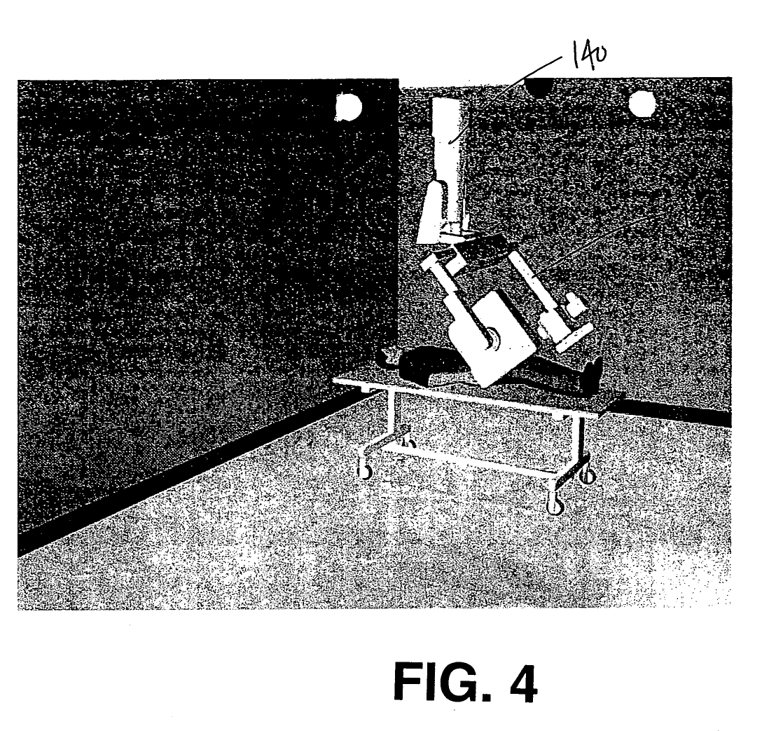

In FIG. 4, mounting member 130 is pivotably moving relative to telescoping member 140 so as to move DR system 100 away from the reclining individual.

In FIG. 5, mounting member 130 is disposed at a 90 degree angle relative to telescoping member 140.

In FIG. 6, telescoping member 140 is translated relative to overhead support 150 to move DR system away from the table on which the individual was reclining.

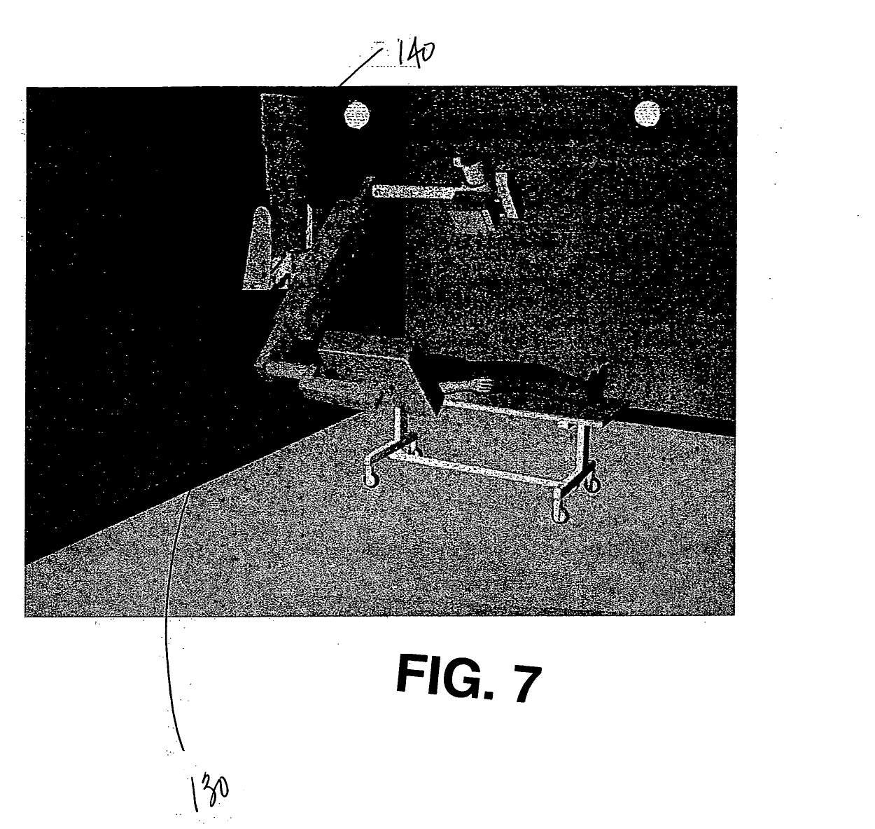

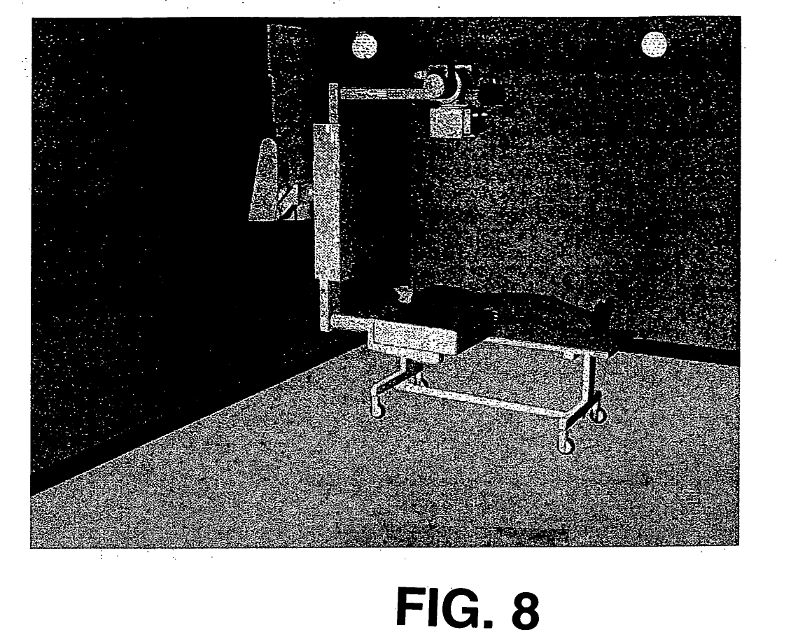

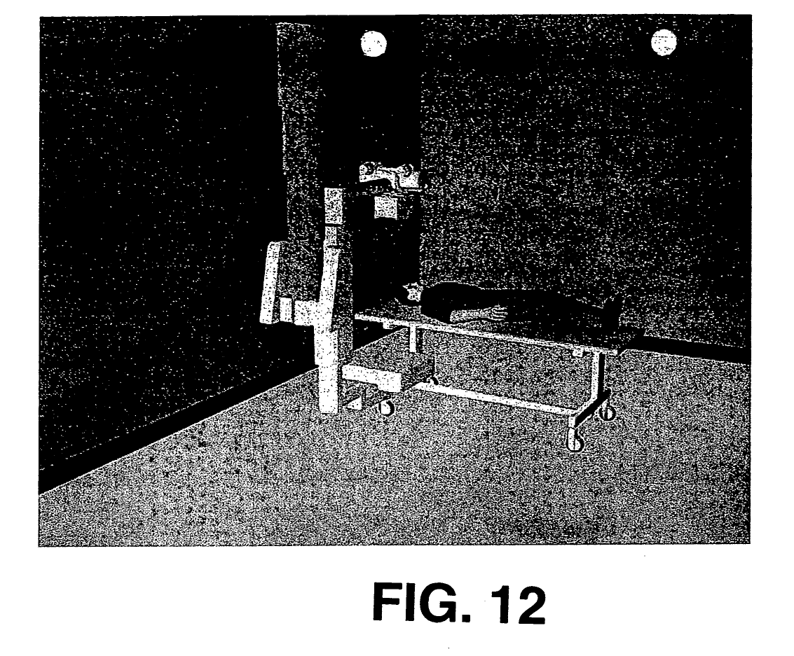

It may be desired to obtain additional images of the reclining individual, but alternate views. Accordingly, as shown in FIGS. 7 and 8, mounting member 130 is rotated relative to telescoping member 140. Then, in FIGS. 9-11, mounting member 130 is rotated about the z-axis. Then, in FIGS. 12-15, the DR system is translated along the overhead structure to move the DR system in position for imaging wherein the x-ray source and detecting member are positioned above/below the reclining individual.

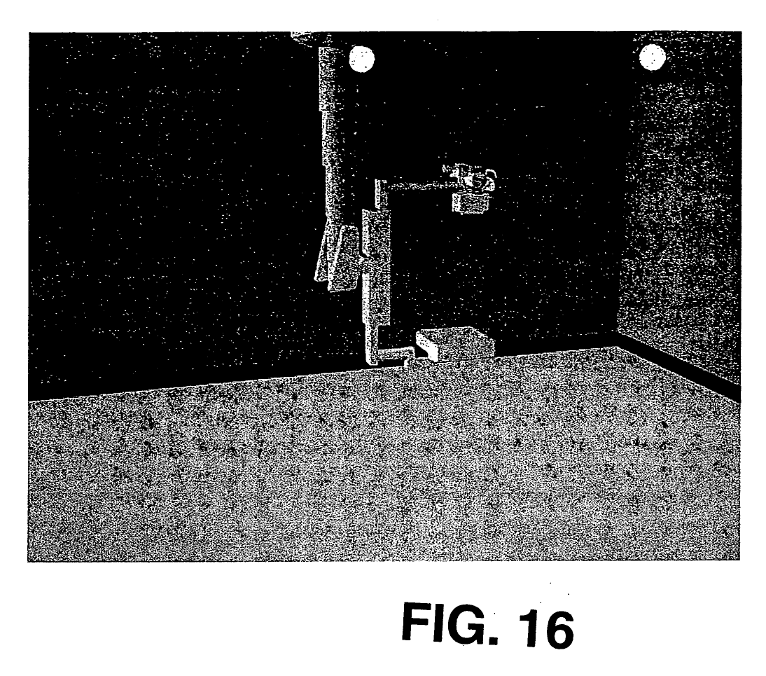

FIG. 16 shows the DR system in the position shown in FIG. 15, with the table and reclining individual removed.

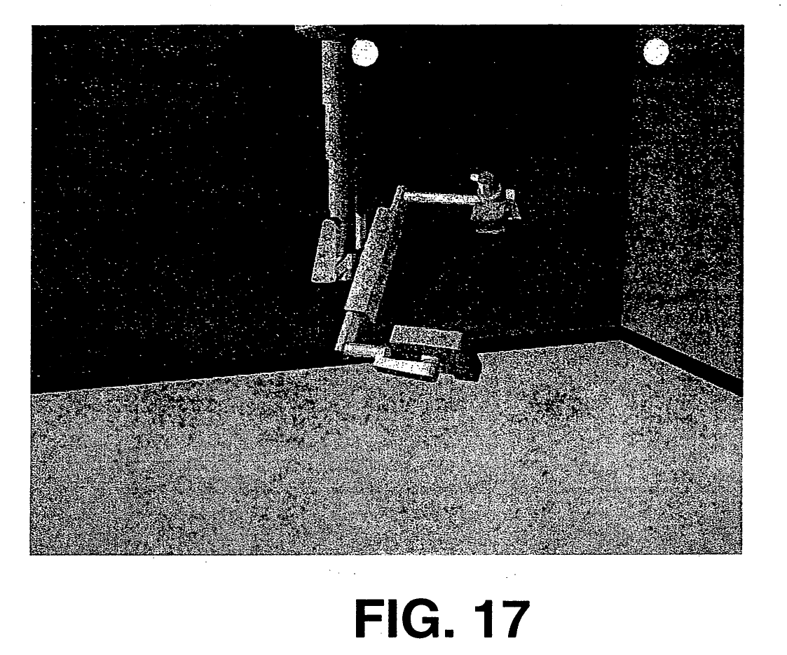

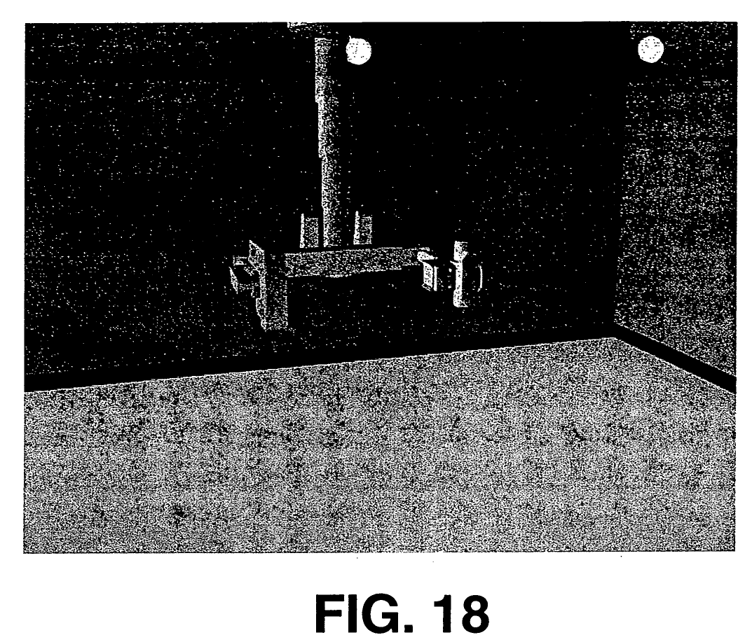

FIGS. 17 and 18 show the DR system in various positions.

FIGS. 19-20 show the translational movement of translation assembly 132 illustrating the opposed, aligned relationship of the x-ray source and detecting member for a standing individual.

As described above, the preset invention is directed to a digital radiography apparatus. A digital radiography apparatus comprises an x-ray source, a detecting member, a mounting member, and a telescoping member. The telescoping member is mounted to an overhead member. One end of the telescoping member is adapted for discrete translational movement along a z-axis such that the one end moves between a first position and a second position extending away from the overhead member. The mounting member is mounted to the one end of the telescoping member and is rotatable about an x-axis and y-axis. The x-ray source and detecting member are mounted to the mounting member in an aligned relationship and are movable in translation relative to each other. In a preferred embodiment, the telescoping member is mounted for translational movement relative to the overhead member.

All documents, patents, journal articles and other materials cited in the present application are hereby incorporated by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A digital radiography apparatus, comprising:
a telescoping member mounted to an overhead member and having one end adapted for discrete translational movement along a z-axis such that the one end moves between a first position and a second position extending away from the overhead member; and
a mounting member mounted to the one end of the telescoping member and rotatable about an x-axis and y-axis, the mounting member including an x-ray source and a detecting member disposed in an aligned relationship and movable in translation relative to each other.

2. The digital radiography apparatus of claim 1, wherein the telescoping member is mounted for translational movement relative to the overhead member.
